(19) United States
(12) Patent Application Publication
(10) Pub. No.: US 2026/0267009 A1
(43) Pub. Date: Sep. 10, 2026

(54) DETERMINING GLOBAL NAVIGATION SATELLITE SYSTEM MEASUREMENT WEIGHTS

(71) Applicant: Samsung Electronics Co., Ltd., Gyeonggi-do (KR)

(72) Inventors: Vincenzo CAPUANO, San Francisco, CA (US); Sundar RAMAN, Fremont, CA (US); Sukhwan LIM, Los Altos, CA (US)

(21) Appl. No.: 19/443,243

(22) Filed: Jan. 8, 2026

Related U.S. Application Data
(60) Provisional application No. 63/768,336, filed on Mar. 7, 2025.

(51) Int. Cl. G01S 19/39; G01S 19/37

(52) U.S. Cl. CPC G01S 19/396; G01S 19/37

(57) ABSTRACT

A system and a method are disclosed for determining global navigation satellite system (GNSS) measurement weighting. Determining the GNSS measurement weighting includes determining, using a processor in a GNSS receiver, at least one of a pseudorange or a pseudorange rate and minimizing, by training a machine learning (ML) model, a prediction error of the at least one of the pseudorange or the pseudorange rate. Determining the GNSS measurement weighting also includes determining, with the ML model, solver weights for a GNSS solver based on the minimization of the prediction error and providing, with the processor, the solver weights to the GNSS solver to predict at least one of a position or a velocity of the GNSS receiver. The prediction error is based on a difference between a predicted measurement error and a true measurement error of the pseudorange and the pseudorange rate.

### CROSS-REFERENCE TO RELATED APPLICATION

This application claims the priority benefit under 35 U.S.C. § 119(e) of U.S. Provisional Application No. 63/768,336, filed on Mar. 7, 2025, the disclosure of which is incorporated by reference in its entirety as if fully set forth herein.

### TECHNICAL FIELD

The disclosure generally relates to global navigation satellite systems (GNSS). More particularly, the subject matter disclosed herein relates to improvements to determining GNSS measurement weights.

### SUMMARY

GNSS provides position data of various constellations of satellites in orbit around the Earth. GNSS includes several constellations such as the Global Position Positioning System (GPS), Galileo, BeiDou, and Globalnaya Navigazionnaya Sputnikovaya Sistema (GLONASS). Each system can be referred to as a constellation. The constellations may be supplemented or enhanced by other orbiting and/or ground station systems such as Japan’s Quasi-Zenith Satellite System (QZSS) and India’s Navigation with Inian Constellation (NavIC).

GNSS satellites broadcast their locations in space, which can be referred to as “ephemeris data,” and that position’s associated time. The time associated with the ephemeris data is typically determined by an atomic clock onboard the broadcasting GNSS satellite. The time associated with the ephemeris data can be referred to as a timestamp. A GNSS receiver can receive the ephemeris data and timestamp. The GNSS receiver knows the timestamped position of the satellite from the ephemeris data. In addition, the GNSS receiver infers the travel time of the signal from the timestamp and the receipt time of the timestamped ephemeris data. The difference between the timestamp and the receipt time is used to determine a distance between the GNSS receiver and the GNSS satellite.

The distance and the location of the GNSS satellite can be used to determine coordinates on a surface of a sphere around the GNSS satellite. Using the same methodology with two or more other GNSS satellites can allow the receiver to estimate its position in a three-dimensional coordinate system. When three GNSS satellites are employed, estimating the position of the GNSS receiver can be called “trilateration.” The estimated position may be based on Earth’s coordinate system and thus be denoted by latitude, longitude, and altitude or elevation.

The estimated distances are used to determine a position of the GNSS receiver are based on the GNSS receiver’s time, which necessarily has an unknown offset or error. A fourth GNSS satellite from the same constellation may be used to estimate the GNSS receiver’s clock error. However, the GNSS receiver’s clock still includes an error. Accordingly, the estimated distances can be referred to as pseudoranges and a time rate of change of that estimated distances can be referred to as pseudorange rates. More than one constellation and/or various methods can be used to improve the accuracy of the pseudoranges and pseudorange rates. However, various factors can affect an accuracy of an estimated position and velocity of a GNSS receiver. The factors include signal multipath, atmospheric effects, and satellite geometry.

To solve this problem, analytical approaches can use precise mathematical models and physical principles to estimate GNSS measurement errors and uncertainty. The analytical approaches, however, are rooted in theory rather than empirical data.

One issue with an analytical approach can be oversimplification that assumes ideal conditions, limiting real-world accuracy.

Another issue with an analytical approach is high complexity for advanced models (e.g., covariance propagation), which can lead to excessive computational demand. An additional issue is that the static nature of the analytical approach lacks adaptability to dynamic environments or unforeseen factors.

To overcome these and other issues, systems and methods are described herein for predicting a pseudorange or pseudorange rate measurement error or weight by, for example, training a machine learning (ML) model while comparing the pseudorange to a ground truth pseudorange and the pseudorange rate to a ground truth pseudorange rate, using either: (1) instantaneous error-based training (comparing pseudoranges to ground truth to minimize individual measurement errors), or (2) solution-based training (directly minimizing position/velocity solution errors by adjusting weights).. Measurement weights determined by the ML model can be provided to a GNSS solver to determine a position and/or velocity based on the pseudorange and/or pseudorange rate and the weights provided to the GNSS solver.

The above approaches improve on previous methods because the minimized error may be accomplished without the computational complexity, assumptions of ideal conditions, or inability to respond to dynamic conditions or other unforeseen conditions.

In an embodiment, a method comprises determining, using a processor in a GNSS receiver, at least one of a pseudorange or a pseudorange rate. The method can also including minimizing, by training the machine learning model, a prediction error of the at least one of the pseudorange and the pseudorange rate. The method can further comprise determining, with the ML model, solver weights for a GNSS solver in the GNSS receiver based on the minimization of the prediction error and providing, with the processor, the solver weights to the GNSS solver to predict at least one of a position and a velocity of the GNSS receiver. The prediction error is based on a difference between a predicted measurement error and a true measurement error of the pseudorange or the pseudorange rate.

In an embodiment, a system comprises a GNSS receiver having a processor configured to determine at least one of a pseudorange or a pseudorange rate and a ML model with two modules: a pseudorange weight predictor and a pseudorange rate weight predictor. The ML model is trained to minimize a prediction error of the at least one of the pseudorange or the pseudorange rate and configure to determine solver weights for a GNSS solver based on the minimization of the prediction error wherein the prediction error is based on a difference between a predicted measurement error and a true measurement error of the pseudorange and pseudorange rate. The processor is configured to provide the solver weights to the GNSS solver to predict at least one of a position and a velocity of the GNSS receiver.

### BRIEF DESCRIPTION OF THE DRAWING

In the following section, the aspects of the subject matter disclosed herein will be described with reference to exemplary embodiments illustrated in the figures, in which:

FIG. 1 is a spatial diagram of a GNSS network 100 according to an embodiment.

FIG. 2 is a block diagram of a ML model 200 according to an embodiment.

FIG. 3 is a block diagram of GNSS position solution 300 according to an embodiment.

FIG. 4 is a block diagram of a GNSS velocity solution 400 according to an embodiment.

FIG. 5 is a block diagram of a system 500 for determining GNSS measurement weights according to an embodiment.

FIG. 6 is a method 600 for GNSS measurement weighting according to an embodiment.

FIG. 7 is a method 700 for determining GNSS measurement weights according to an embodiment.

FIG. 8 is a method 800 for determining GNSS measurement weights according to an embodiment.

FIG. 9 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

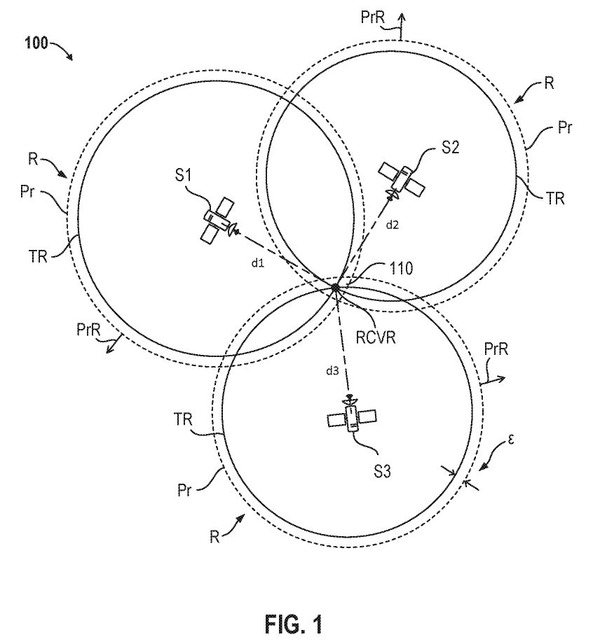

FIG. 1 is a spatial diagram of a GNSS network 100 according to an embodiment.

Referring to FIG. 1, the GNSS network 100 includes three GNSS satellites referenced as S1, S2, S3. The GNSS satellites S1, S2, S3 are positioned about a GNSS receiver R. Distances d1, d2, d3 between the satellites S1, S2, S3 and the receiver can be referred to as true distances. Ranges R illustrated as circles about the satellites S1, S2, S3 represent calculated ranges between the GNSS receiver RCVR and the satellites S1, S2, S3. The circles intersect at or about the GNSS receiver RCVR. The ranges R represented by solid circles intersect at the GNSS receiver RCVR and thus represent true ranges TR. The ranges R represented by dashed circles intersect at multiple points around the GNSS receiver RCVR and thus are not true. Instead, the dashed circles represent pseudoranges PR. More specifically, The pseudoranges PR represent calculated ranges that include errors ε from factors like signal multipath, atmospheric effects, and satellite geometry. These errors ε are addressed by applying weights to individual measurements to account for their varying quality. Also shown are pseudorange rates PrR that represent a rate of change in the pseudorange Pr, represented by arrows. It should be appreciated that pseudorange Pr may be different between the satellites S1, S2, S3. Similarly, the pseudorange rate PrR may differ between the satellites S1, S2, S3.

As explained with reference to FIG. 1, GNSS networks 100 can provide a reliable means of obtaining position and velocity information. However, the accuracy of GNSS solutions can be compromised by various factors such as signal multipath, atmospheric effects, and satellite geometry. These errors are typically addressed by applying weights to individual measurements. Traditional deterministic approaches (e.g., using C/N0 or elevation) are limited in adapting to dynamic environments and measurement conditions, as they only partially reflect true uncertainty.

These deterministic approaches may use signal characteristics like carrier-to-noise ratio (C/N0) or satellite elevation, which may only partially reflect the true uncertainty of each measurement. Deterministic approaches may have limited ability to adapt to dynamic environments and measurement conditions. ML can improve GNSS weighting strategies by leveraging data-driven models capable of capturing complex relationships among measurement features and their associated uncertainties.

For example, ML techniques may be more suitable to address various conditions not adequately addressed by deterministic approaches, such as environmental dependencies, sensor fusion, user motion complexity, bias and/or noise management, etc. Environmental dependency may be due to environmental factors such as multipath interference, atmospheric conditions (ionospheric and tropospheric effects), and obstructions like buildings or trees. Sensor fusion can include integrating sensor data such as inertial measurement units (IMU), barometric, and/or the like with GNSS measurements. User motion complexity can include user movements in complex environments that may induce rapid signal fluctuations. GNSS measurements can have bias and/or noise that are difficult for deterministic approaches to resolve. A ML model can address these and other issues.

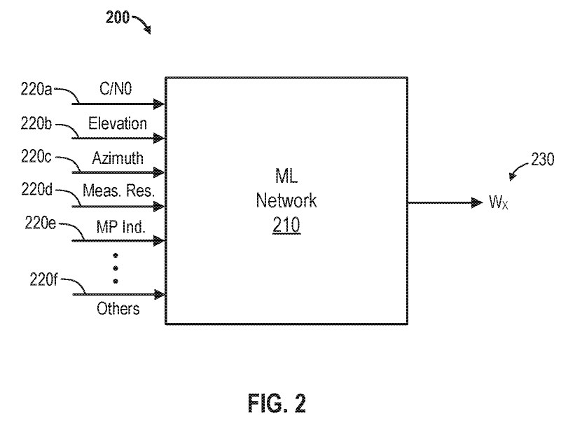

FIG. 2 is a block diagram of a ML model 200 according to an embodiment.

Referring to FIG. 2, the ML model 200 includes an ML network 210, inputs 220, and an output 230. The ML network 210 may be a multilayer neural network that is trained to minimize an error. The error may be minimized using any suitable means, such as by comparison between an output based on the ML network 210 and a ground truth value, as will be described in more detail herein. Referring still to FIG. 2, the inputs 220 to the ML network 210 include a carrier-to-noise ratio (C/N0), an elevation, an azimuth, measurement residuals, multipath indicators, and others, although any suitable inputs can be employed. The ML model 200 also includes the output 230, which is comprised of a GNSS weight Wx. The GNSS weight Wx can be used in a GNSS solver to determine a position and/or velocity of a GNSS receiver, such as the GNSS receiver R described with reference to FIG. 1.

The ML network 210 may be any suitable ML network that includes ML weights to the inputs 220 and between layers. An input layer of the ML network 210 can receive the inputs 220 and provide weighted inputs to a subsequent hidden layers. The weighted inputs values are determined based on values of the input 220 multiplied by the ML weights of the ML network. During training, the ML weights can be adjusted to minimize a predicted measurement error, such an error in the pseudorange and/or pseudorange rate values or an error in a position and/or velocity of a GNSS receiver.

The inputs 220 may be comprised of a carrier-to-noise ratio C/N0 220a, an elevation 220b, an azimuth 220c, measurement residuals 220d, multipath indicators 220e, etc. The inputs 220 may be contributors to the error ε described with reference to FIG. 1. Accordingly, the inputs 220 may be used during training of the ML network 210 to minimize a predicted measurement error. The C/N0 220a is a measure of the quality of a GNSS signal received by a GNSS receiver. The C/N0 220a can be expressed in decibels-Hertz (dB-Hz) values. The C/N0 220a is calculated by dividing the carrier power C by a noise power density N₀. A larger C/N0 220a means higher quality GNSS signals.

The elevation 220b may be a GNSS satellite’s angle above a horizon of Earth relative to the GNSS receiver. A carrier signal from a GNSS satellite directly over the receiver may transit less atmosphere than a GNSS satellite that is at or near Earth’s horizon. The elevation 220b can be determined from the ephemeris data provided by the GNSS satellite. A higher elevation 220b is generally correlated with higher quality carrier signals.

The azimuth 220c can be a direction of a GNSS satellite providing the carrier signal. The azimuth 220c is used to determine a relative angle of the GNSS receiver and the satellite. The alignment of the antennas can affect an accuracy of measurements by the GNSS receiver.

The measurement residuals 220d can be a difference between a predicted value of a measurement and a measured value. For example, the measurement residuals 220d can be a different between a predicted range or a measured pseudorange of the GNSS receiver. The GNSS receiver can predict the range based on prior-in-time measured values, such as a prior-in-time pseudorange value and a prior-in-time pseudorange rate value, such as, for example, the pseudorange Pr and pseudorange rate PrR described with reference to FIG. 1.

The multipath indicators 220e are values that can indicate whether a signal is the result of a reflection, diffraction, etc. The multipath indicators 220e can include a comparison of code and carrier-phase observations, signal analysis techniques that identify multiple signal components, etc. Environmental factors such as the proximity of tall buildings, foliage, etc. can be multipath indicators. The multipath indicators 220e can be correlated with a likelihood of interference.

The other input 220f can be any other value that may affect a measurement accuracy of a solver. That is, the other input 220f may be any input that can be used to predict a measurement error. The other input 220f may be representative of a single or an aggregation of values. For example, some inputs may be combined and or the like. Additionally, or alternatively, inputs other than the inputs 220 described with reference to FIG. 2 may be employed.

The inputs 220 are received by the ML network 210 which can be trained to minimize an error, such as an error in a position and/or velocity of the GNSS receiver. For example, a ground truth value of the position and velocity of the GNSS receiver can be utilized.

The ML network 210 uses a dedicated pseudorange weight prediction module and a separate pseudorange rate weight prediction module. The dedicated pseudorange weight prediction module may predict GNSS weights for pseudorange values that are used in a GNSS solver that determines, for example, a velocity. The pseudorange rate weight prediction module may predict GNSS weights for pseudorange rate values used in a GNSS solver that determines, for example, a velocity.

Each module processes input features (e.g., the C/N0 220a, elevation 220b, azimuth 220c, etc.) to generate GNSS weights optimized for position and velocity estimation, respectively. For example, referring to FIG. 2, each module predicts the optimal GNSS weight for a given measurement based on input features such as the C/N0 220a, elevation 220b, azimuth 220c, measurement residuals 220d, multipath indicators 220e, and other relevant metrics indicated by other inputs 220f. Because the

There may be two distinct approaches for training the ML model 200. A first approach may be an instantaneous error-based training (IEBT). In IEBT, the ML network 210 can be trained to predict the instantaneous error of individual measurements, minimizing the error prediction for each measurement. These predicted measurement errors are then used to compute GNSS weights for positioning and velocity estimation. A second approach may be a solution-based training (SBT). In SBT, the ML network 210 may be trained to directly optimize the position and velocity solution by minimizing the overall estimation error resulting from processing a number of weighted measurements with a specific solver (e.g., weighted least squares, Kalman filter, or factor graph). Other training models may be employed.

Referring to FIG. 2, the resulting GNSS weights Wx can be the output 230. The resulting GNSS weights Wx may be integrated into a suitable weighted GNSS solver, enabling significant improvements in the accuracy and robustness of GNSS positioning and velocity solutions, particularly in challenging environments.

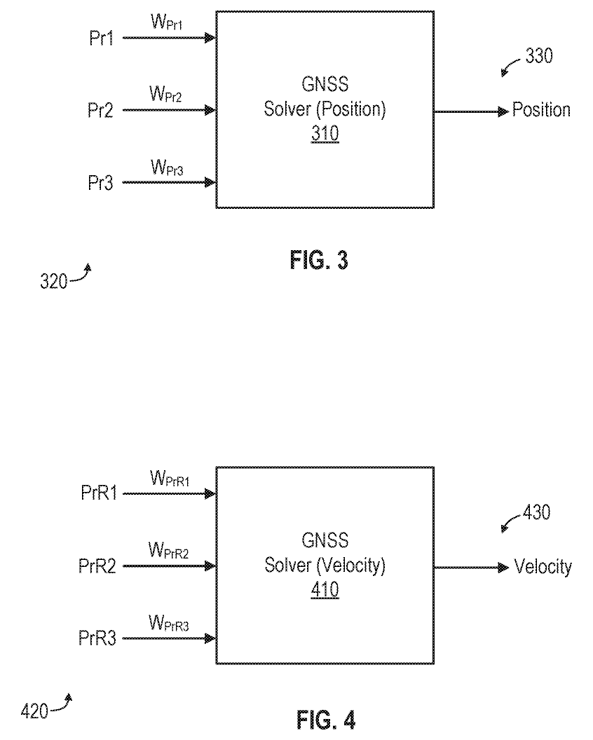

FIG. 3 is a block diagram of GNSS position solution 300 according to an embodiment.

Referring to FIG. 3, the GNSS position solution 300 includes a GNSS solver 310, inputs 320, and an output 330. The GNSS solver 310 may provide a position based on four or more pseudoranges determined based on signals provided by four or more GNSS satellites. The inputs 320 provide four pseudoranges labeled Pr1, Pr2, Pr3 and Pr4, although more inputs may be employed. The four pseudoranges are respectively multiplied by a first through fourth GNSS pseudorange weight W_{Pr1}, W_{Pr2}, W_{Pr3,} W_{Pr4}. The first through fourth GNSS pseudorange weight W_{Pr1}, W_{Pr2}, W_{Pr3,} W_{Pr4} can be determined by a ML model, such as the ML model 200 described with reference to FIG. 2, although any suitable ML model can be employed. The output 330 can be a position of a GNSS receiver having the GNSS position solution 300.

FIG. 4 is a block diagram of a GNSS velocity solution 400 according to an embodiment.

Referring to FIG. 4, the GNSS velocity solution 400 includes a GNSS solver 410, inputs 420, and an output 430. The GNSS solver 410 may be provide a position based on four or more pseudoranges determined based on signals provided by four or more GNSS satellites. The inputs 420 provide four pseudorange rates labeled PrR1, PrR2, PrR3 and PrR4, although more inputs may be employed. The four pseudorange rates are respectively multiplied by a first through fourth pseudorange rate weight W_{PrR1}, W_{PrR2}, W_{PrR3,} W_{PrR4}. The first through fourth pseudorange rate weights W_{PrR1}, W_{PrR2}, W_{PrR3,} W_{PrR4} can be determined by a ML model, such as the ML model 200 described with reference to FIG. 2, although any suitable ML model can be employed. The output 430 can be a velocity of a GNSS receiver having the GNSS velocity solution 400.

Referring to FIGS. 3 and 4, the GNSS solvers 310, 410 can be any suitable solver that can employ one or more GNSS weights applied to one or more pseudoranges Pr and/or pseudorange rates PrR. For example, the GNSS solvers 310, 410 may be include weighted least squares, a Kalman filter, factor graph, etc.

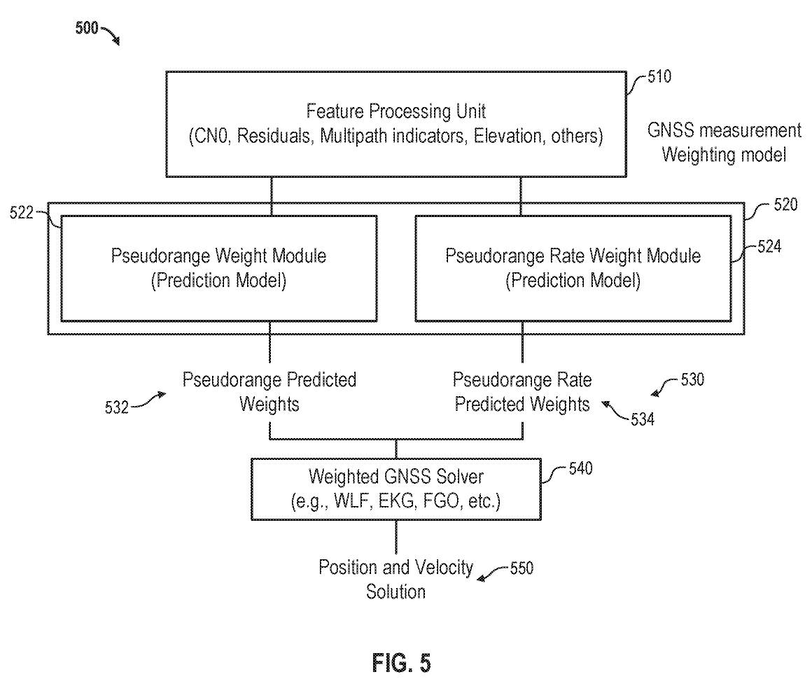

FIG. 5 is a block diagram of a system 500 for determining GNSS measurement weights according to an embodiment.

Referring to FIG. 5, a features processing unit 510 is communicatively coupled to measurement prediction model 520. The measurement prediction models 520 may be a pseudorange weight module 522 and a pseudorange rate weight module 524. The pseudorange weight module 522 and pseudorange rate weight module 524 are communicatively coupled with a weighted GNSS solver 540, which can provide a position and velocity solution 550

The features processing unit 510 can be comprised of various processors and other units that can determine values of features associated with a signal from a GNSS satellite. For example, values of features such as a C/N0, elevation, azimuth, etc., can be determined using various telemetry equipment that may be in communication with a GNSS constellation. The telemetry equipment can receive carrier signals from the GNSS constellation to determine the values of the features, which can be used to train the pseudorange weight module 522 and the pseudorange rate weight module 524.

The pseudorange weight module 522 and the pseudorange rate weight module 524 can be trained to minimize a prediction error. The prediction error may be, for example, a difference between a predicted measurement error and a true measurement error of a pseudorange and/or a pseudorange rate. With reference to FIG. 1, the error ε is shown as a difference between the true range Tr and a pseudorange Pr. The error ε may therefore be a true measurement error of the pseudorange Pr. The pseudorange weight module 522 and the pseudorange rate weight module 524 may predict a measurement error which can be compared to the true measurement error.

The ML weights of the pseudorange weight module 522 and the pseudorange rate weight module 524 can be adjusted while, for example, comparing the predicted measurement error with the true measurement error. By way of illustration, prediction errors can be continuously generated after iteratively adjusting ML weight values in the pseudorange weight module 522 and the pseudorange rate weight module 524 and compared to the true measurement error. When adjustments to the ML weights only generate greater prediction errors than the predicted weights, which may be GNSS weights, to the pseudorange weight

module 522 and the pseudorange rate weight module 524 can be provided to the weighted GNSS solver 540.

The pseudorange weight module 522 and pseudorange rate weight module 524 are configured to provide predicted weights 530, such as the GNSS weights Wx described with reference to FIG. 2, to the weighted GNSS solver 540.The predicted weights 530 is comprised of pseudorange predicted weights 532 and pseudorange rate predicted weights 534. The weighted GNSS solver 540 receives the GNSS pseudorange predicted weights 532 and pseudorange rate predicted weights 534. The weighted GNSS solver 540 applies (e.g., multiplies) the pseudorange predicted weights 532 and pseudorange rate predicted weights 534 to pseudorange and pseudorange rate values to determine a position and/or a velocity solution 550.

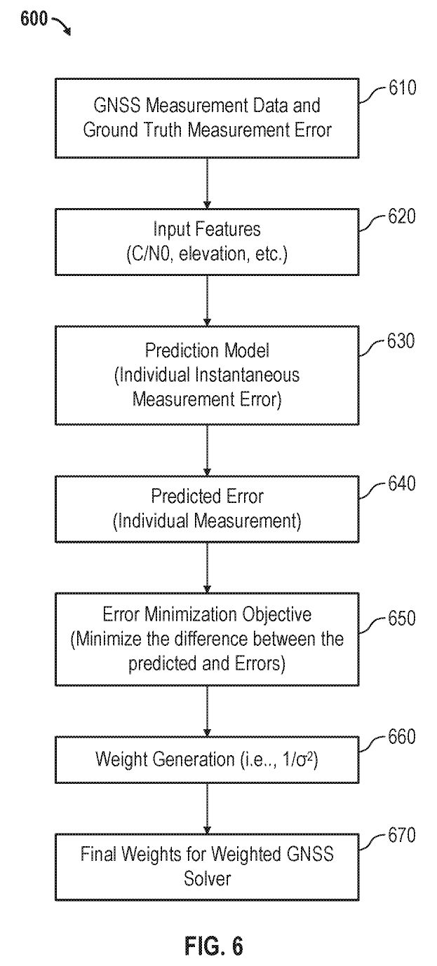

FIG. 6 is a method 600 for GNSS measurement weighting according to an embodiment.

Referring to FIG. 6, the method 600 may predict instantaneous measurement errors and converting them into weights. The method 600 can obtain a GNSS measurement data and ground truth measurement error in step 610. The GNSS measurement data can be the pseudoranges and the pseudorange rates described, for example, with reference to FIG. 3.

In step 620, the method 600 can obtain input features in step 610, such as a C/N0, an elevation, etc. The input features can be obtained by a GNSS receiver, such as the GNSS receiver R described with reference to FIG. 1. The input features can include data provided by GNSS satellites or data regarding the environment, such as multipath indicators. For example, the input features of step 620 can be the features described with reference to FIG. 5, such as the C/N0, elevation, azimuth, etc.

At step 630, the method 600 obtains a prediction model of individual instantaneous measurement errors. The prediction model may be for predicting pseudoranges and pseudorange rates described with reference to FIGS. 3 and 4. Alternatively, the prediction model of step 630 may include the pseudorange weight module 522 and/or the pseudorange rate weight module 524 described with reference FIG. 5. The prediction model can include seed weights and input rows configured to accept values of features that can be input into the prediction model.

The predicted errors for individual measurements, such as a pseudorange or pseudorange rates, may be determined at step 640. The predicted errors may be, for example, a prediction of a difference between a true range and a pseudorange. The predicted errors can be determined from, for example, the pseudorange weight module 522 and the pseudorange rate weight module 524 described with reference to FIG. 5.

The method 600 performs an error minimization objective at step 650, where the difference between the predicted and ground truth errors are minimized. The minimization of the errors may occur during training of an ML model, such as the ML model 200 described with reference to FIG. 2. The minimization may include repeatedly adjusting ML weights in the ML network 210 and regenerating, for example, the pseudorange and pseudorange rate values that are compared to a true error value. The process can be repeated until a measurement prediction error is obtained.

In step 660, the method 600 generates the GNSS weights at step 660, which may be based on or related to an inverse of a standard deviation of the measurement, such as the pseudorange or pseudorange rate.

The method 600 at step 670 obtains final GNSS weights for the weighted GNSS solver. The final GNSS weights may be suitable for any type of GNSS solver. The final GNSS weights may be based on a minimization of a measurement prediction error in the pseudoranges and/or pseudorange rates.

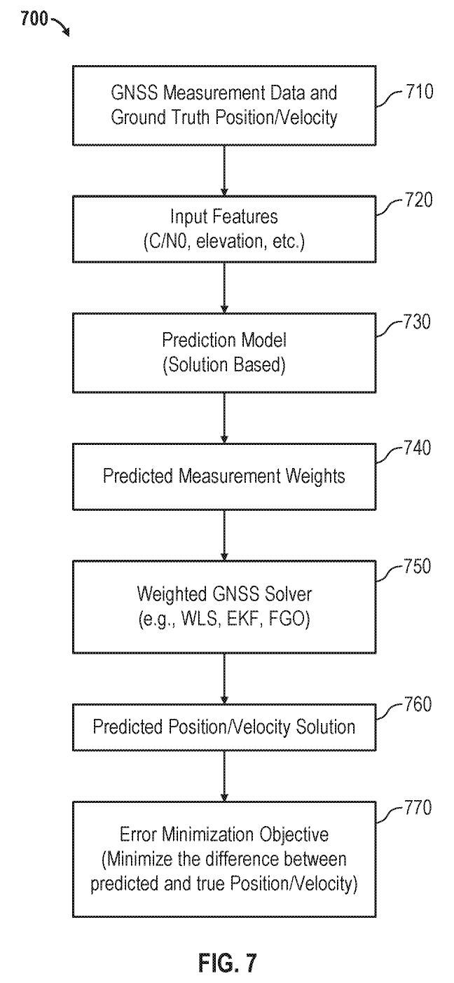

FIG. 7 is a method 700 for determining GNSS measurement weights according to an embodiment.

Referring to FIG. 7, the method 700 provides a solution level optimization process. The method 700 determines GNSS measurement data and a ground truth position and velocity at step 710. The GNSS measurement data can be a travel time of the carrier signal received by the GNSS receiver, ephemeris data provided by the satellite, etc.

Input features, such as a C/N0, elevation, etc. are obtained in step 720. The input features can be obtained by a GNSS receiver, such as the GNSS receiver R described with reference to FIG. 1. The input features can include data provided by GNSS satellites or data regarding the environment, such as multipath indicators.

In step 730, the method 700, a solutions-based prediction model is obtained. The solutions based prediction model may be ML model, such as the ML network 210 described with reference to FIG. 2 with weights determined through a measurement error minimization process. The measurement error minimization process may be the method 600 described with reference to FIG. 6.

The method 700, at step 740 obtains predicted measurement weights. The predicted measurement weights may be obtained from the ML model described with reference to step 730 where the weights are obtained through a measurement error minimization process.

At step 750, the method 700 applies the predicted measurement weights to the GNSS solver, which may be a WLS, EKF, FGO, etc., model. The weighted GNSS solver can multiply the measurement weights with pseudorange and pseudorange rate values, as is shown, for example, in FIGS. 3 and 4.

The method 700, at step 760 can predict a position and/or velocity solution for the GNSS receiver. The position and/or velocity can be predicted using the GNSS solver employing the weights obtained from the ML model at step 750. For example, referring to FIGS. 3 and 4, the method 700 can obtain predicted positions and velocity from the multiplication of the measurement weights with the pseudorange and pseudorange rates.

At step 770, the method 700 performs an error minimization objective, which is to minimize the difference between a predicted and ground truth position and/or velocity. The minimization objective may be to adjust the weights in the GNSS solver so that a difference between the predicted position and/or velocity and the ground truth position and/or velocity is minimized.

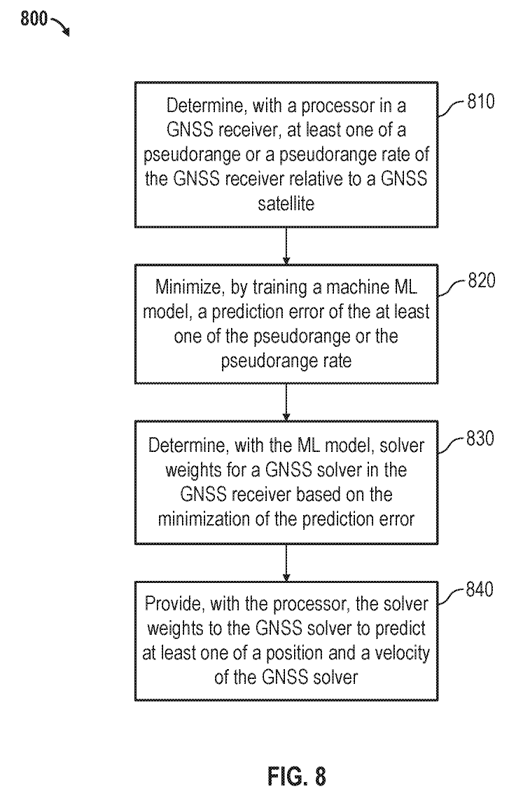

FIG. 8 is a method 800 for determining GNSS measurement weights according to an embodiment.

Referring to FIG. 8, the method 800 may determine, with a processor in a GNSS receiver, at least one of a pseudorange or a pseudorange rate of the GNSS receiver relative to a GNSS satellite in step 810. In step 820, the method 800 may minimize, by training a ML model, a prediction error of the at least one of the pseudorange or the pseudorange rate, The method 800 can also determine, with the ML model, solver weights for a GNSS solver in the GNSS receiver based on the minimization of the prediction error in step 830. In step 840, the method 800 can provide, with the processor, the solver weights to the GNSS solver to predict at least one of a position or a velocity of the GNSS receiver. The prediction error may be based on a difference between a predicted measurement error and a true measurement error of the pseudorange or the pseudorange rate.

The method 800 may further comprise predicting, with the GNSS solver, the at least one of the position or the velocity of the GNSS receiver by applying, with the GNSS solver, the solver weights to the at least one of the pseudorange or the pseudorange rate. The method 800 may further include minimizing the prediction error of the at least one of the pseudorange or the pseudorange rate by comparing, with the ML model, predicted measurement error with a true measurement error.

Additionally, or alternatively, the method 800 can further comprise minimizing the prediction error of the last least one of the pseudorange and the pseudorange rate by adjusting ML weights in a ML model. Adjusting the ML weights in the ML model may include adjusting the ML weights applied to feature inputs received by the ML model. The method 800 can also include minimizing an error between a predicted position and a ground truth position and an error between a predicted velocity and a ground truth velocity.

The solver weights provided to the GNSS solver may be proportional to an inverse of a variance of a predicted measurement error of the pseudorange and the pseudorange rate. The method 800 can also determine the at least one of the pseudorange or the pseudorange rate by determining the at least one of the pseudorange or the pseudorange rate based on a transit time of a carrier signal and ephemeris data received from a GNSS satellite.

Additionally, or alternatively, the method 800 can further include predicting the at least one of the position or the velocity of the GNSS receiver by predicting, with the GNSS solver, the at least one of the pseudorange or the pseudorange rate relative to at least four GNSS satellites. The GNSS solver may include a weighted least squares, a Kalman filter, or a factor graph, although any suitable GNSS solver may be employed.

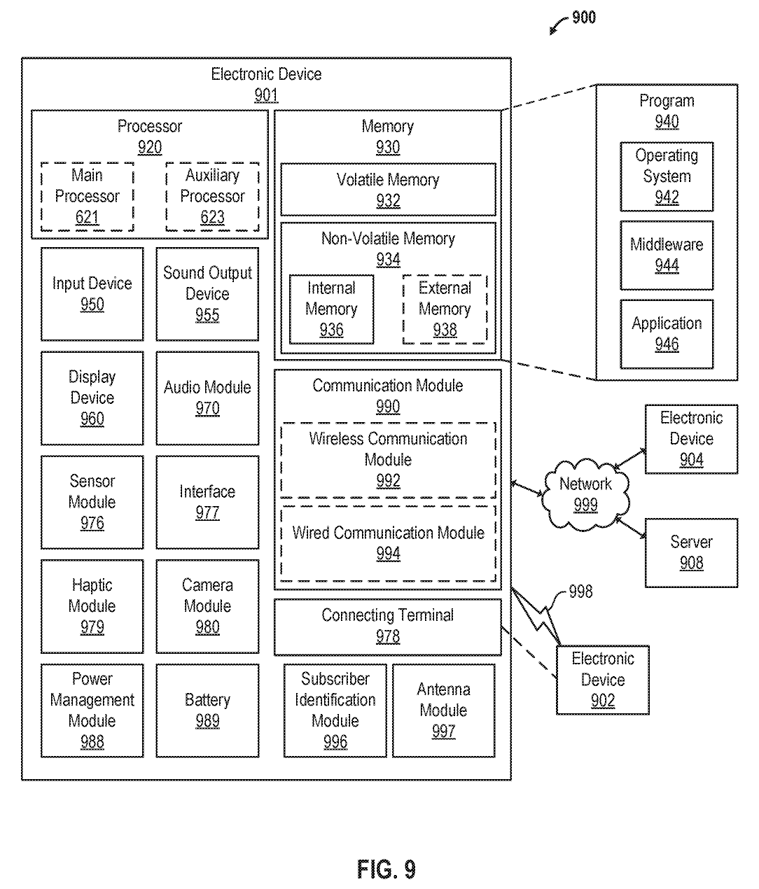

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations. For example, the processor may receiver measurement data from a GNSS satellite via a receiver and determine a pseudorange and pseudorange rate of the electronic device 901 relative to a GNSS satellite. Accordingly, the electronics device 901 can be a GNSS receiver, such as a cell phone, marine buoys, surveying equipment, roadside telemetry devices, etc. A machine learning model, which may or may not be in the electronic device 901, can determine solver weights for a GNSS solver in the electronic device 901.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high- definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a GNSS communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH^{TM}, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 901 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus.

Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
determining, with a processor in a global navigation satellite system (GNSS) receiver, at least one of a pseudorange or a pseudorange rate of the GNSS receiver relative to a GNSS satellite;
minimizing, by training a machine learning (ML) model, a prediction error of the at least one of the pseudorange or the pseudorange rate;
determining, with the ML model, solver weights for a GNSS solver in the GNSS receiver based on the minimization of the prediction error; and
providing, with the processor, the solver weights to the GNSS solver to predict at least one of a position or a velocity of the GNSS receiver;
wherein the prediction error is based on a difference between a predicted measurement error and a true measurement error of the pseudorange or the pseudorange rate.

2. The method of claim 1, further comprising predicting, with the GNSS solver, the at least one of the position or the velocity of the GNSS receiver by applying, with the GNSS solver, the solver weights to the at least one of the pseudorange or the pseudorange rate.

3. The method of claim 1, further comprising minimizing the prediction error of the at least one of the pseudorange or the pseudorange rate by comparing, with the ML model, predicted measurement error with a true measurement error.

4. The method of claim 1, further comprising minimizing the prediction error of the last least one of the pseudorange and the pseudorange rate by adjusting machine leaning (ML) weights in a ML model.

5. The method of claim 4, further comprising adjusting the ML weights in the ML model by adjusting the ML weights applied to feature inputs received by the ML model.

6. The method of claim 1, further comprising minimizing an error between a predicted position and a ground truth position and an error between a predicted velocity and a ground truth velocity.

7. The method of claim 1, wherein the solver weights provided to the GNSS solver are proportional to an inverse of a variance of a predicted measurement error of the pseudorange and the pseudorange rate.

8. The method of claim 1, further comprising determining the at least one of the pseudorange or the pseudorange rate by determining the at least one of the pseudorange or the pseudorange rate based on a transit time of a carrier signal and ephemeris data received from a GNSS satellite.

9. The method of claim 1, further comprising predicting the at least one of the position or the velocity of the GNSS receiver by predicting, with the GNSS solver, the at least one of the pseudorange or the pseudorange rate relative to at least four GNSS satellites.

10. The method of claim 1, wherein the GNSS solver comprises one of a weighted least squares, a Kalman filter, or a factor graph.

11. A system comprises:
a global navigation satellite system (GNSS) receiver having a processor configured to determine at least one of a pseudorange or a pseudorange rate relative to a GNSS satellite; and
a machine learning (ML) model:
trained to minimize a prediction error of the at least one of the pseudorange or the pseudorange rate, wherein the prediction error is based on a difference between a predicted measurement error and a true measurement error of the pseudorange or pseudorange rate; and
configured to determine solver weights for a GNSS solver based on the minimization of the prediction error;
wherein the processor is configured to provide the solver weights to the GNSS solver to predict at least one of a position or a velocity of the GNSS receiver.

12. The system of claim 11, wherein the prediction error is based on a difference between a predicted measurement error and a true measurement error of the pseudorange or the pseudorange rate.

13. The system of claim 11, further comprising the GNSS solver predicting the at least one of the position or the velocity of the GNSS receiver by the GNSS solver being configured to apply the solver weights to the at least one of the pseudorange or the pseudorange rate.

14. The system of claim 11, further comprising the ML model being configured to minimize the prediction error of the at least one of the pseudorange or the pseudorange rate by the ML model being configured to compare a predicted measurement error with a true measurement error.

15. The system of claim 11, further comprising ML model being configured to minimize the prediction error of the last least one of the pseudorange and the pseudorange rate by the ML model being configured to adjust ML weights in the ML model.

16. The system of claim 15, further comprising the ML model being configured to adjust the ML weights by the ML model being configured to adjust the ML weights applied to feature inputs received by the ML model.

17. The system of claim 11, further comprising the ML model being configured to minimize an error between a predicted position and a ground truth position and an error between a predicted velocity and a ground truth velocity.

18. The system of claim 11, wherein the solver weights provided to the GNSS solver are proportional to an inverse of a variance of a predicted measurement error of the pseudorange and the pseudorange rate.

19. The system of claim 11, further comprising the GNSS receiver being configured to determine the at least one of the pseudorange or the pseudorange rate by the GNSS receiver being configured to determine the at least one of the pseudorange or the pseudorange rate based on a transit time of a carrier signal and ephemeris data received from a GNSS satellite.

20. The system of claim 11, further comprising the GNSS solver being configured to predict the at least one of the position or the velocity of the GNSS receiver by the GNSS solver being configured to predict the at least one of the pseudorange or the pseudorange rate relative to at least four GNSS satellites.

21. The system of claim 11, wherein the GNSS solver comprises one of a weighted least squares, a Kalman filter, or a factor graph.
